(19) United States
(12) Patent Application Publication
(10) Pub. No.: US 2026/0143599 A1
(43) Pub. Date: May 21, 2026

(54) ORDERING OF BAY IDENTIFIERS IN AN ELECTRONIC MODULE

(71) Applicant: HEWLETT PACKARD ENTERPRISE DEVELOPMENT LP, Spring, TX (US)

(72) Inventors: Kun-You Cai, Taipei (TW); Yan-Tang Liu, Taipei (TW); Ku-Hsu Nien, Taipei (TW); Pei-Chieh Chou, Taipei (TW)

(21) Appl. No.: 18/954,644

(22) Filed: Nov. 21, 2024

(51) Int. Cl. H05K 5/02

(52) U.S. Cl. CPC H05K 5/0217; H05K 5/0291

(57) ABSTRACT

In some examples, an electronic module includes a moveable contact engageable with a housing of a system based on a mounting orientation of the electronic module in the system. The electronic module includes a plurality of bays to receive devices, and a memory including a first memory location storing identifiers of the plurality of bays in a first order, and a second memory location storing the identifiers of the plurality of bays in a second order different from the first order. The electronic module includes a switch assembly to selectively select the first memory location or the second memory location based on a position of the moveable contact.

### BACKGROUND

Electronic modules can include devices to perform functionalities in systems in which the electronic modules are mounted. The devices included in the electronic modules may be any of the following: storage devices, memory devices, processors, input/output (I/O) devices, accelerators, or other types of devices.

### BRIEF DESCRIPTION OF THE DRAWINGS

Some implementations of the present disclosure are described with respect to the following figures.

FIG. 1 is a block diagram of a system in which an electronic module has been mounted in a first orientation, according to some examples.

FIG. 2 is a block diagram of a system in which an electronic module has been mounted in a second orientation different from the first orientation, according to some examples.

FIG. 3 is a block diagram of a bay reordering mechanism, according to some examples.

FIG. 4 is a block diagram of an electronic module to some examples.

FIG. 5 is a block diagram of a system according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

An electronic module may be removably mounted in a system, such as a computer, a communication node, a storage system, a vehicle, an appliance, or any other type of system. For example, the system may include a connector to which the electronic module may be connected. The connector of the system may be on a main circuit board, a controller board, or any other type of support structure. In some cases, electronic modules may be multipurpose modules that can be used in different types of systems with different designs. For example, different systems may have different form factors. In other examples, different systems may have mounting structures to attach to electronic modules.

Multipurpose electronic modules may be mounted in different types of systems in respective different orientations. An electronic module may include multiple bays to receive respective devices. The bays may allow devices to be removably attached to the electronic device. A “bay” can refer to a receptacle or a connector that is able to mechanically and electrically engage a device. The bays may be arranged an expected order. For example, if the bays are assigned bay numbers, then a first bay in the order can be assigned bay number BN1, a second bay in the order can be assigned bay number BN2, and so forth. A manufacturer of a system in which the electronic module is to be mounted may expect the bay numbers assigned to the bays to follow the expected order. For example, the expected order may be left to right or top to bottom, with the bay at the extreme left or at the top being assigned bay number BN1, and the bay at the extreme right or bottom being assigned the last bay number. More specifically, in an example, if there are four bays, then the leftmost first bay is assigned BN1, the second bay to the right of the first bay is assigned BN2, the third bay to the right of the second bay is assigned BN3, and the rightmost fourth bay is assigned BN4. In another example, the top first bay is assigned BN1, the second bay below the first bay is assigned BN2, the third bay below the second bay is assigned BN3, and the fourth bottom bay is assigned BN4. In other examples, bays of an electronic module may have a different expected order, depending upon the convention or standard that the ordering of bays is to follow.

Because multipurpose electronic modules may be arranged in different orientations in different types of systems, in some cases, bays of an electronic module may be out of order when mounted in a system. For example, if the electronic module is mounted in a first system in a first orientation (e.g., a horizontal orientation), then the bays of the electronic module may be in the expected order. However, if the electronic module is mounted in a second system in a different second orientation (e.g., a vertical orientation), then the bays of the electronic module may not be in the expected order, and in fact, may be in a reverse order that is the reverse of the expected order. The electronic module may interact with an external controller that may expect the bays to be in the expected order. If the bays are not in the expected order, the external controller may access a device in the wrong bay. For example, the external controller may request an access of a device in bay number BN1, but if the order of bays of the electronic module is in the reverse order, the device actually accessed may be in bay number BN4. This can result in wrong data being retrieved, or in write data being written to the wrong device that can lead to data corruption and errors. More generally, accessing a device in the wrong bay of an electronic module due to the order of bays of the electronic module being different from the expected order can lead to erroneous or unexpected interactions between the electronic module and the external controller.

In accordance with some implementations of the present disclosure, a bay reordering mechanism is provided in an electronic module to automatically reorder bays (for receiving respective devices) of the electronic module based on a mounting orientation of the electronic module in a system. The bay reordering mechanism includes a moveable contact engageable with a system housing of the system based on the mounting orientation of the electronic module. If the electronic module is mounted in a first orientation in the system, the moveable contact engages with the system housing and is actuated to a first position. If the electronic module is mounted in a different second orientation in the system, the moveable contact does not engage the system housing, and the moveable contact is at a second position different from the first position.

The bay reordering mechanism further includes a memory and a switch assembly. The memory includes multiple memory locations to store identifiers of the bays (“bay identifiers”). The multiple memory locations include a first memory location storing the bay identifiers in a first order, and a second memory location storing the bay identifiers in a second order different from the first order. The switch assembly of the bay reordering mechanism selectively selects the first memory location or the second memory location based on a position of the moveable contact. The selected memory location is connected to a bus, and an external controller can access the bay identifiers from the connected memory location over the bus.

In some examples, the memory is implemented with multiple memory devices. In such examples, the first memory location is in a first memory device, and the second memory location is in a second memory device. In alternative examples, the multiple memory locations may be included in the same memory device.

The switch assembly includes one or more switches. A switch can include a transistor, such as a field effect transistor (FET), a bipolar junction transistor (BJT), or another type of transistor. In other examples, other types of electronic switches can be used in the switch assembly.

A “bay identifier” can refer to any identification information that distinguishes one bay from another bay of an electronic module. The bay identifier can include a bay number in some examples. In other example, the bay identifier can include an alphanumeric string or any other type of identifier.

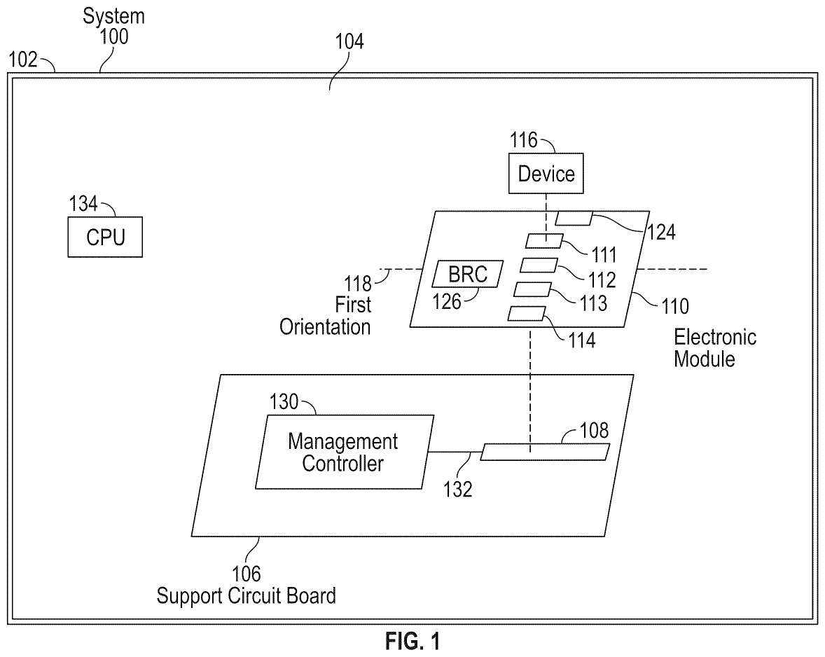

FIG. 1 is a block diagram of a system 100 that has a system housing 102 that defines an inner space 104 in which various components are contained. Examples of the components include a support circuit board 106 that has a connector 108 to removably engage with an electronic module 110. The support circuit board 106 can be a main circuit board, a controller circuit board, or any other type of circuit board to which the electronic module 110 can attach. More generally, the system 100 can include a support structure to which the electronic module 110 can be mounted.

In some examples, the electronic module 110 can also be a circuit board. In other examples, the electronic module 110 can include an integrated circuit device. The connector 108 of the support circuit board 106 can mechanically and electrically engage with a connector (not shown) of the electronic module 110.

The electronic module 110 includes multiple bays 111, 112, 113, and 114 to receive respective devices. In the example of FIG. 1, the bay 111 can receive a device 116. Other devices (not shown) may be received in the other bays 112, 113, and 114. Although FIG. 1 shows that the electronic module 110 has four bays, it is noted that in a different example, the electronic module 110 can include a different quantity of bays (two or more bays). Examples of devices that can be received in the bays 111, 112, 113, and 114 include any or some combination of the following: storage devices, memory devices, processors, input/output (I/O) devices, accelerators, or other types of devices.

In the example of FIG. 1, the electronic module 110 is mounted to the support circuit board 106 in a first orientation 118 in the system 100. In the first orientation 118, the bays 111, 112, 113, and 114 of the electronic module 110 are arranged in a top-down arrangement in the view of FIG. 1, with the bay 111 at the top and the bay 114 at the bottom.

The electronic module 110 further includes a movable contact 124 and a bay reordering circuit (BRC) 126. The movable contact 124 and the BRC 126 are part of a bay reordering mechanism that can automatically reorder bays of the electronic module 110 based on an orientation of the electronic module 110 when mounted in a system.

The movable contact 124 can be moved between a first position (corresponding to when the movable contact 124 engages with a system housing) or a second position (corresponding to when the movable contact 124 does not engage a system housing). In the depicted example, it is assumed that when the electronic module 110 is mounted in the first orientation 118 in the system 100, the movable contact 124 engages with the system housing 102 and thus the movable contact 124 has been actuated to the engaged position.

In some examples, the movable contact 124 is a spring-loaded contact. When the spring-loaded contact is engaged to the system housing 102, the engagement acts against a biasing force of the spring-loaded contact to move the spring-loaded contact to the engaged position. However, if the spring-loaded contact is not engaged with a system housing, the spring-loaded contact remains in the disengaged position.

The support circuit board 106 includes a management controller 130 that can perform various management operations in the system 100. An example of the management controller 130 is a baseboard management controller (BMC). In other examples, other types of management controllers can be employed. Examples of management operations that can be performed by the management controller 130 include power control in the system 100, thermal control in the system 100, or other types of management operations.

The management controller 130 is connected over a bus 132 to the connector 108. When the electronic module 110 is connected to the connector 108, the management controller 130 is able to communicate over the bus 132 with the electronic module 110. In some examples, the bus 132 is an Inter-Integrated Circuit (I²C) bus used for communicating management data as part of management operations of the management controller 130. In other examples, other types of management buses can be employed, such as a Serial Peripheral Interface (SPI) bus or another type of bus.

The management controller 130 is separate from a central processing unit (CPU) 134 of the system 100. The CPU 134 may be mounted on the support circuit board 106 or another circuit board of the system 100. The CPU 134 executes primary machine-readable instructions of the system 100, such as an operating system (OS), system firmware, and an application program. The system firmware can include Basic Input/Output System (BIOS) code or Universal Extensible Firmware Interface (UEFI) code. The CPU 134 can include one or more hardware processors.

In some examples, the management controller 130 is able to interact with the electronic module 110 over the bus 132. For example, the management controller 130 can perform management tasks with devices received in the bays 111, 112, 113, and 114, including configuring the devices, accessing the devices to obtain information of the devices, or other management tasks. The management controller 130 may expect that the bays 111, 112, 113, and 114 are in an expected order. For example, in the top-down arrangement of FIG. 1, a convention or standard may specify that the bay 111 at the top should be assigned a first bay identifier (e.g., bay number BN1), the bay 112 below the bay 111 should be assigned a second bay identifier (e.g., bay number BN2), the bay 113 below the bay 112 should be assigned a third bay identifier (e.g., bay number BN3), and the bay 114 at the bottom should be assigned a fourth bay identifier (e.g., bay number BN4).

The BRC 126 includes a memory that has memory location A and memory location B. Memory location A stores a first sequence of bay identifiers, e.g., {BN1, BN2, BN3, BN4} in this first order. Memory location B stores a second sequence of bay identifiers, e.g., {BN4, BN3, BN2, BN1} in this second order. The first and second sequences of bay identifiers have opposite orders of bay identifiers.

The BRC 126 selects one of memory location A and memory location B based on the position (engaged position or disengaged position) of the movable contact 124. If the movable contact 124 is in the engaged position (as shown in FIG. 1), the BRC 126 selects memory location A and outputs the first sequence of bay identifiers, e.g., {BN1, BN2, BN3, BN4}. On the other hand, if the movable contact 124 is in the disengaged position, the BRC 126 selects memory location B and outputs the second sequence of bay identifiers, e.g., {BN4, BN3, BN2, BN1}.

Although some examples refer to two memory locations containing two respective sequences of bay identifiers, in further examples, a BRC may include more than two memory locations containing respective different sequences of bay identifiers that correspond to more than two different orientations of an electronic module mounted in a system.

The sequence of bay identifiers output by the BRC 126 is provided to the management controller 130 over the bus 132. The management controller 130 uses the received sequence of bay identifiers from the BRC 126 to perform management tasks with the devices received in the bays 111, 112, 113, and 114. For example, the management controller 130 can perform a management task with a device connected to the bay identified by the j-th bay identifier, where the j-th bay identifier is one of the first, second, third, and fourth bay identifiers.

In addition to storing bay identifiers, memory locations A and B can also store configuration information associated with the bays. In some examples, the management controller 130 can write the configuration information for each bay on the electronic module 110 during manufacture of the system 100 or when maintenance or a repair is being performed. Examples of configuration information that may be written to a memory location of a BRC can include information of the electronic module 110 (e.g., a serial number of the electronic module 110, a model of the electronic module 110) as well as other information.

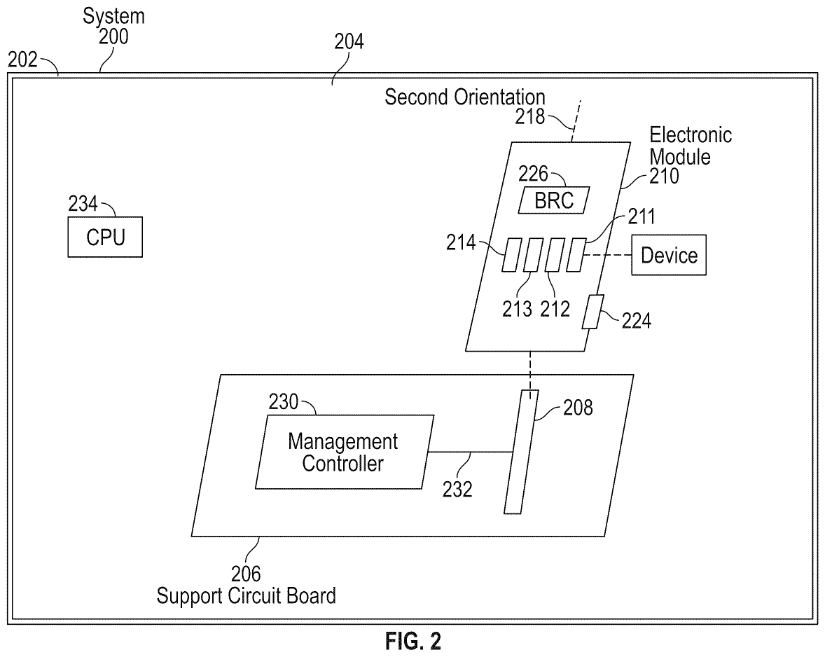

FIG. 2 is a block diagram of a system 200 that has a system housing 202 defining an inner space 204 in which various components can be included. Similar to the system 100, the components of the system 200 include a support circuit board 206 with a connector 208 to removably engage with an electronic module 210. In the example of FIG. 2, the electronic module 210 is mounted to the support circuit board 206 in a second orientation 218 in the system 200, where the second orientation 218 is different from the first orientation 118 of FIG. 1. Note that the connector 208 has an orientation on the support circuit board 206 that is different from the orientation of the connector 108 on the support circuit board 106 of FIG. 1. The different orientation of the connector 208 causes the orientation of the electronic module 210 to be different from the orientation of the electronic module 110 of FIG. 1.

Note that the electronic module 210 of FIG. 2 may be identical or similar to the electronic module 110 of FIG. 1, except for the different orientations of the electronic modules 210 and 110. A further difference is that a movable contact 224 of the electronic module 210 is in the disengaged position because the movable contact 224 is not engaged to the system housing 202 when the electronic module 210 is mounted in the second orientation 218.

The electronic module 210 includes bays 211, 212, 213, and 214. In the second orientation 218, the bay 214 is the leftmost bay and the bay 211 is the rightmost bay in a left-right arrangement. A convention or standard may specify that the leftmost bay should be assigned the first bay identifier and the rightmost bay should be assigned the fourth bay identifier. Thus, the expected order from left to right is that the bay 214 is assigned the first bay identifier (e.g., BN1), the bay 213 is assigned the second bay identifier (e.g., BN2), the bay 212 is assigned the third bay identifier (e.g., BN3), and the bay 211 is assigned the fourth bay identifier (e.g., BN4).

The electronic module 210 also includes a BRC 226 having a memory including memory location A and memory location B (similar to the BRC 126 of FIG. 1). Memory location A in the BRC 226 stores the first sequence of bay identifiers, and memory location B in the BRC 226 stores the second sequence of bay identifiers. If the first sequence of bay identifiers in memory location A is used, then the bay 214 would be assigned the fourth bay identifier (e.g., BN4), the bay 213 would be assigned the third bay identifier (e.g., BN3), the bay 212 would be assigned the second bay identifier (e.g., BN2), and the bay 211 would be assigned the first bay identifier (e.g., BN1). In the left-right arrangement, the bays 214, 213, 212, and 211 would thus be assigned respective fourth, third, second, and first bay identifiers, which is the opposite of the expected order.

In accordance with some examples of the present disclosure, because the movable contact 224 is in the disengaged position, the BRC 226 selects memory location B and outputs the second sequence of bay identifiers, e.g., {BN4, BN3, BN2, BN1}, for use by a management controller 230 on the support circuit board 206. The management controller 230 is connected by a bus 232 to the connector 208. The second sequence of bay identifiers includes the first bay identifier assigned to the bay 214, the second bay identifier assigned to the bay 213, the third bay identifier assigned to the bay 212, and the fourth bay identifier assigned to the bay 211, which is according to the expected order.

The system 200 further includes a CPU 234 that is separate from the management controller 230. The CPU 234 can execute primary machine-readable instructions of the system 200.

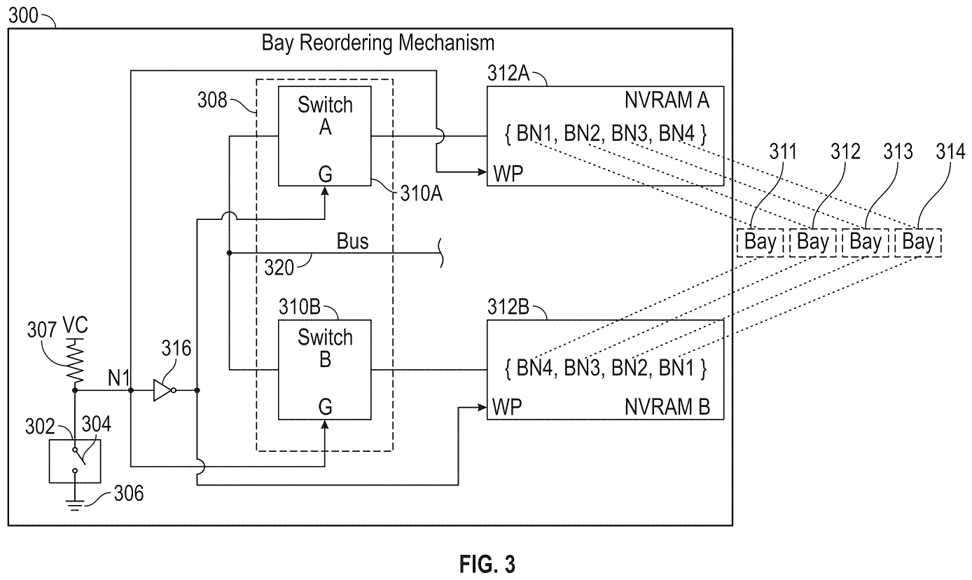

FIG. 3 is a diagram of a bay reordering mechanism 300 according to some examples of the present disclosure. The bay reordering mechanism 300 includes a spring-loaded contact 302, which is an example of the movable contact 124 or 224 in FIG. 1 or 2. The spring-loaded contact 302 includes an electrical switch 304 that is in the open position. The electrical switch 304 is in the open position if the spring-loaded contact 302 is not engaged with a system housing (e.g., 102 or 202 in FIG. 1 or 2). The electrical switch 304 is in the closed position if the spring-loaded contact 302 is engaged with a system housing.

In the open position of the switch 304, node N1 is disconnected from ground 306 (or another low voltage). Node N1 provides a control signal that controls a switch assembly 308 including a switch 310A and a switch 310B. The switches 310A and 310B are connected to respective memory devices 312A and 312B. In some examples, the memory devices 312A and 312B are nonvolatile random access memory (NVRAM) devices. An NVRAM device maintains data stored in the NVRAM device even if power were removed from the NVRAM device.

The control signal provided by node N1 also controls write protect (WP) inputs of the memory devices 312A and 312B. When a WP input of a memory device is active (e.g., high), any attempt to write to the memory device is blocked. When the WP input of the memory device is inactive (e.g., low), a write to the memory device is allowed to complete.

The switch 310A is connected between a data port of the memory device 312A and a bus 320. Similarly, the switch 310B is connected between a data port of the memory device 312B and the bus 320. In some examples, the switches 310A and 310B can be implemented using transistors, such as FETs, BJTs, or other types of transistors.

The bus 320 is connected through a connector (e.g., 108 or 208 in FIG. 1 or 2) to the bus 132 or 232 on a support circuit board (e.g., 106 or 206). The memory devices 312A and 312B are accessible to a management controller (e.g., 130 or 230) through the bus 320, the connector 108 or 208, and the bus 132 or 232. The management controller can read from the memory device 312A or 312B, and the management controller can write to the memory device 312A or 312B.

Node N1 is connected to an input of an inverter 316. The output of the inverter 316 provides an inverse control signal (that is the inverse of the control signal provided by node N1). The inverse control signal is connected to the control gate (G) of the switch 310A and to the WP input of the memory device 312B. The control signal of node N1 is connected to the control gate (G) of the switch 310B and the WP input of the memory device 312A. When the control gate (G) of a switch is active (e.g., high), the switch is activated so that data can pass through the switch. When the control gate (G) of the switch is inactive (e.g., low), the switch is deactivated so that data cannot pass through the switch.

Node N1 is coupled through a pullup resistor 307 to a power supply voltage VC. The combination of elements including the switch assembly 308, the memory devices 312A, 312B, the pullup resistor 307, and the inverter 316 forms a BRC, such as the BRC 126 or 226 of FIG. 1 or 2.

If the switch 304 of the spring-loaded contact 302 is in the open position, then node N1 is pulled high to VC through the pullup resistor 307. However, if the switch 304 is in the closed position, then node N1 is pulled low to ground 306.

If the switch 304 is open due to the spring-loaded contact 302 being in the disengaged position, node N1 is high which activates the switch 310B and deactivates the switch 310A. Also, when node N1 is high, the WP input of the memory device 312A is active, and the WP input of the memory device 312B is inactive. As a result, the memory device 312B is connected through the activated switch 310B to the bus 320. The management controller can perform a read or write through the activated switch 310B with respect to the memory device 312B. However, the management controller is unable to perform a read or write through the deactivated switch 310A with respect to the memory device 312A.

If the switch 304 is closed due to the spring-loaded contact 302 being in the engaged position, then node N1 is pulled low, which deactivates the switch 310B and activates the switch 310A. Also, the low state of node N1 sets the WP input of the memory device 312A inactive, and sets the WP input of the memory device 312B active. As a result, the memory device 312A is connected through the activated switch 310A to the bus 320. The management controller can perform a read or write through the activated switch 310A with respect to the memory device 312A. However, the management controller is unable to perform a read or write through the deactivated switch 310B with respect to the memory device 312B.

As shown in FIG. 3, the memory device 312A stores a first sequence of bay identifiers, e.g., {BN1, BN2, BN3, BN4}, and the memory device 312B stores a second sequence of bay identifiers, e.g., {BN4, BN3, BN2, BN1}. If the memory device 312A is selected, then the first sequence of bay identifiers is output over the bus 320 to the management controller. In this case, a bay 311 is assigned BN1, a bay 312 is assigned BN2, a bay 313 is assigned BN3, and a bay 314 is assigned BN4. The bays 311, 312, 313, and 314 may be part of an electronic module, such as the electronic module 110 or 210 of FIG. 1 or 2.

However, if the memory device 312B is selected, then the second sequence of bay identifiers is output over the bus 320 to the management controller. In this case, the bay 311 is assigned BN4, the bay 312 is assigned BN3, the bay 313 is assigned BN2, and the bay 314 is assigned BN1.

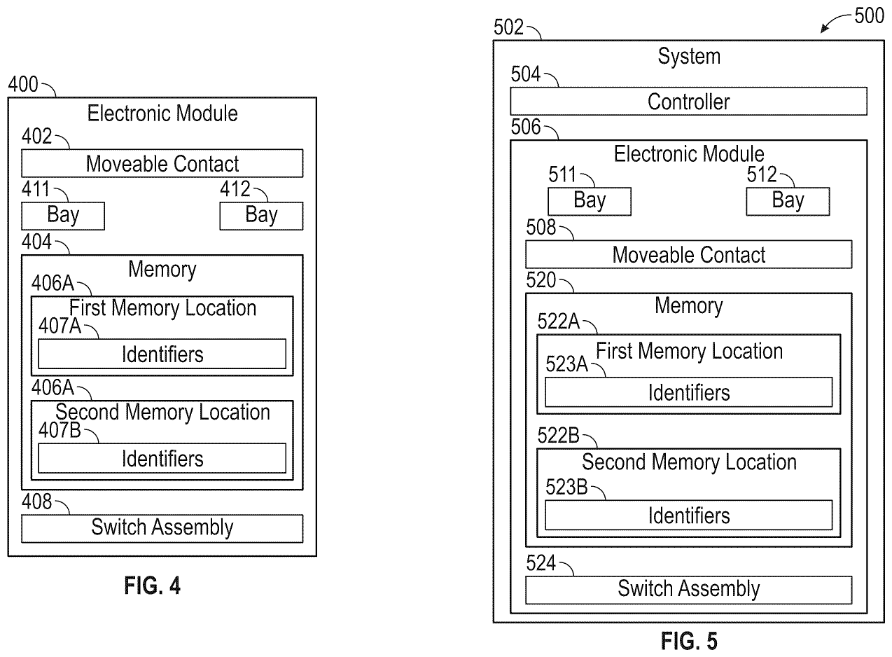

FIG. 4 is a block diagram of an electronic module 400 according to some examples of the present disclosure. The electronic module 400 is an example of the electronic module 110 or 210 of FIG. 1 or 2.

The electronic module 400 includes a moveable contact 402 engageable with a housing of a system based on a mounting orientation of the electronic module in the system. The system may be the system 100 or 200 of FIG. 1 or 2.

The electronic module 400 includes a plurality of bays 411 and 412 to receive respective devices. The bays 411 and 412 can include receptacles or connectors, for example. In further examples, more than two bays may be present in the electronic module 400.

The electronic module 400 includes a memory 404 including a plurality of memory locations to store identifiers of the plurality of bays 411 and 412. The plurality of memory locations include a first memory location 406A storing the identifiers 407A of the plurality of bays 411 and 412 in a first order, and a second memory location 406B storing the identifiers 407B of the plurality of bays 411 and 412 in a second order different from the first order. The memory 404 may be implemented using one or more memory devices, such as the memory devices 312A and 312B of FIG. 3.

The electronic module 400 includes a switch assembly 408 including a switch. In some examples, the switch assembly 408 may include multiple switches, such as the switches 310A and 310B of FIG. 3. In other examples, the switch assembly 408 may include a single switch. The switch assembly 408 selectively selects the first memory location 406A or the second memory location 406B based on a position of the moveable contact 402.

In some examples, the electronic module 400 further includes a bus. The switch assembly 408 connects the first memory location 406A to the bus based on a first position of the moveable contact 402 if the electronic module 400 is mounted in the system in a first orientation. The switch assembly 408 connects the second memory location 406B to the bus based on a second position of the moveable contact 402 if the electronic module 400 is mounted in the system in a second orientation different from the first orientation.

In some examples, the second memory location 406B is disconnected from the bus by the switch assembly 408 responsive to the first position of the moveable contact 402. The first memory location 406A is disconnected from the bus by the switch assembly 408 responsive to the second position of the moveable contact 402.

In some examples, the identifiers of the plurality of bays are accessible to an external controller over the bus from a selected memory location of the first and second memory locations 406A and 406B based on which of the first and second memory locations is connected by the switch assembly 408 to the bus. The external controller can be the management controller 130 or 230 of FIG. 1 or 2, for example. Alternatively, the external controller can be a CPU (e.g., 134 or 234) or another electronic component.

In some examples, the switch assembly 408 is controllable by a control signal, and the moveable contact 402 when in a first position sets the control signal to a first state, and the moveable contact 402 when in a second position sets the control signal to a second state different from the first state. An example of the control signal is provided by node N1 in FIG. 3.

In some examples, the memory 404 a first memory device and a second memory device. The first memory location is in the first memory device, and the second memory location is in the second memory device.

In some examples, the electronic module 400 further includes a bus. The switch assembly 408 includes a first switch that when activated connects the first memory device to the bus, and a second switch that when activated connects the second memory device to the bus.

In some examples, the first memory device includes a first write protect input, and the second memory device includes a second write protect input. The first write protect input is activated to block a write to the first memory device responsive to the moveable contact being in a first position, and the second write protect input is activated to block a write to the second memory device responsive to the moveable contact being in a second position different from the first position.

In some examples, a selected memory device of the first and second memory devices is written with information of the electronic module when a write protect input of the selected memory device is deactivated.

In some examples, the moveable contact 402 is engaged with the housing of the system if the electronic module 400 is mounted in a first orientation in the system, and the moveable contact 402 is disengaged with the housing of the system if the electronic module 400 is mounted in a second orientation in the system.

FIG. 5 is a block diagram of a system 500 according to some examples of the present disclosure. The system 500 can be an example of the system 100 or 200 of FIG. 1 or 2.

The system 500 includes a housing 502, a controller 504, and an electronic module 506. The controller 504 may be a management controller (e.g., 130 or 230), a CPU (e.g., 134 or 234), or another electronic component.

The electronic module 506 includes a plurality of bays 511 and 512 to receive devices. In further examples, more than two bays may be present in the electronic module 506.

The electronic module 506 includes a moveable contact 508 engageable with the housing 502 based on a mounting orientation of the electronic module 506 in the system 500.

The electronic module 506 includes a memory 520 including a plurality of memory locations to store identifiers of the plurality of bays 511 and 512. The plurality of memory locations include a first memory location 522A storing the identifiers 523A of the plurality of bays 511 and 512 in a first order, and a second memory location 522B storing the identifiers of the plurality of bays 511 and 512 in a second order different from the first order.

The electronic module 506 includes a switch assembly 524 including one or more switches. The switch assembly 524 selectively selects the first memory location 522A or the second memory location 522B based on a position of the moveable contact 508. The controller 504 can access the identifiers of the plurality of bays in a selected memory location of the first and second memory locations 522A and 522B.

In some examples, the first order and the second order are opposite orders of the identifiers of the plurality of bays.

In some examples, the moveable contact 508 includes an electrical switch (e.g., 304 in FIG. 3) that is open based on the moveable contact 508 being in a first position, and that is closed based on the moveable contact 508 being in a second position different from the first position. The electrical switch being open causes a control signal to the switch assembly 524 to have a first state, and the electrical switch being closed causing the control signal to the switch assembly 524 to have a second state different from the first state.

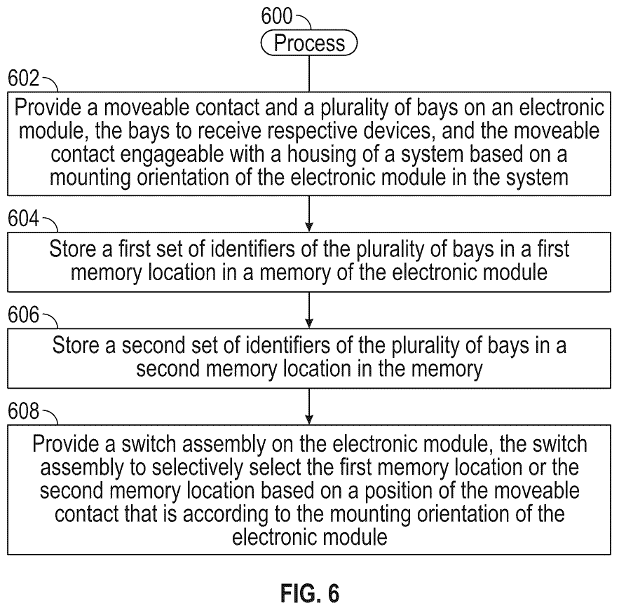

FIG. 6 is a flow diagram of a process 600 according to some examples of the present disclosure. The process 600 includes providing (at 602) a moveable contact and a plurality of bays on an electronic module, the bays to receive respective devices, and the moveable contact engageable with a housing of a system based on a mounting orientation of the electronic module in the system.

The process 600 includes storing (at 604) a first set of identifiers of the plurality of bays in a first memory location in a memory of the electronic module, and storing (at 606) a second set of identifiers of the plurality of bays in a second memory location in the memory. The identifiers of the plurality of bays in the first memory location are in a first order, and the identifiers of the plurality of bays in the second memory location are in a second order different from the first order.

The process 600 includes providing (at 608) a switch assembly on the electronic module, the switch assembly to selectively select the first memory location or the second memory location based on a position of the moveable contact that is according to the mounting orientation of the electronic module.

As used here, a “hardware processor” can include a microprocessor, a core of a multi-core microprocessor, a microcontroller, a programmable integrated circuit, a programmable gate array, or another hardware processing circuit.

A “BMC” can refer to a specialized service controller that monitors the physical state of a system using sensors and communicates with a remote management system (that is remote from the system) through an independent “out-of-band” connection. The BMC can perform management tasks to manage components of the system. Examples of management tasks that can be performed by the BMC can include any or some combination of the following: power control to perform power management of the system (such as to transition the system between different power consumption states in response to detected events), thermal monitoring and control of the system (such as to monitor temperatures of the system and to control thermal management states of the system), fan control of fans in the system, system health monitoring based on monitoring measurement data from various sensors of the system, remote access of the system (to access the computer system over a network, for example), remote reboot of the system (to trigger the computer system to reboot using a remote command), system setup and deployment of the system, system security to implement security procedures in the system, and so forth.

In some examples, the BMC can provide so-called “lights-out” functionality for the system. The lights out functionality may allow a user, such as a systems administrator, to perform management operations on the system even if an OS is not installed or not functional on the system.

Moreover, in some examples, the BMC can run on auxiliary power provided by an auxiliary power source; as a result, the system does not have to be powered on to allow the BMC to perform the BMC's operations. The auxiliary power source is separate from a primary power supply that supplies powers to other components (e.g., a main processor, a memory, an I/O device, etc.) of the system.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An electronic module for use in a system, comprising:
a moveable contact engageable with a housing of the system based on a mounting orientation of the electronic module in the system;
a plurality of bays to receive devices; and
a memory comprising a plurality of memory locations to store identifiers of the plurality of bays, the plurality of memory locations comprising a first memory location storing the identifiers of the plurality of bays in a first order, and a second memory location storing the identifiers of the plurality of bays in a second order different from the first order; and
a switch assembly comprising a switch, the switch assembly to selectively select the first memory location or the second memory location based on a position of the moveable contact.

2. The electronic module of claim 1, comprising:
a bus,
wherein the switch assembly is to:
connect the first memory location to the bus based on a first position of the moveable contact if the electronic module is mounted in the system in a first orientation, and
connect the second memory location to the bus based on a second position of the moveable contact if the electronic module is mounted in the system in a second orientation different from the first orientation.

3. The electronic module of claim 2, wherein the second memory location is disconnected from the bus by the switch assembly responsive to the first position of the moveable contact, and
wherein the first memory location is disconnected from the bus by the switch assembly responsive to the second position of the moveable contact.

4. The electronic module of claim 2, wherein the identifiers of the plurality of bays are accessible over the bus from a selected memory location of the first and second memory locations based on which of the first and second memory locations is connected by the switch assembly to the bus.

5. The electronic module of claim 4, wherein the identifiers of the plurality of bays are accessible over the bus from the selected memory location to a controller outside the electronic module.

6. The electronic module of claim 1, wherein the moveable contact comprises a spring-loaded contact.

7. The electronic module of claim 1, wherein the switch assembly is controllable by a control signal, and wherein the moveable contact when in a first position sets the control signal to a first state, and the moveable contact when in a second position sets the control signal to a second state different from the first state.

8. The electronic module of claim 1, wherein the memory comprises a first memory device and a second memory device, the first memory location is in the first memory device, and the second memory location is in the second memory device.

9. The electronic module of claim 8, comprising:
a bus,
wherein the switch assembly comprises:
a first switch that when activated connects the first memory device to the bus, and
a second switch that when activated connects the second memory device to the bus.

10. The electronic module of claim 8, wherein the first memory device comprises a first write protect input, and the second memory device comprises a second write protect input, and
wherein the first write protect input is activated to block a write to the first memory device responsive to the moveable contact being in a first position, and
wherein the second write protect input is activated to block a write to the second memory device responsive to the moveable contact being in a second position different from the first position.

11. The electronic module of claim 10, wherein a selected memory device of the first and second memory devices is written with information of the electronic module when a write protect input of the selected memory device is deactivated.

12. The electronic module of claim 1, wherein the moveable contact is engaged with the housing of the system if the electronic module is mounted in a first orientation in the system, and the moveable contact is disengaged with the housing of the system if the electronic module is mounted in a second orientation in the system.

13. A system comprising:
a housing;
a controller; and
an electronic module comprising:
a plurality of bays to receive devices,
a moveable contact engageable with the housing based on a mounting orientation of the electronic module in the system, and
a memory comprising a plurality of memory locations to store identifiers of the plurality of bays, the plurality of memory locations comprising a first memory location storing the identifiers of the plurality of bays in a first order, and a second memory location storing the identifiers of the plurality of bays in a second order different from the first order, and
a switch assembly comprising a switch, the switch assembly to selectively select the first memory location or the second memory location based on a position of the moveable contact, and
wherein the controller is to access the identifiers of the plurality of bays in a selected memory location of the first and second memory locations.

14. The system of claim 13, wherein the electronic module further comprises a bus, and wherein the switch assembly is to:
connect the first memory location to the bus and isolate the second memory location from the bus based on a first position of the moveable contact if the electronic module is mounted in the system in a first orientation, and
connect the second memory location to the bus and isolate the first memory location from the bus based on a second position of the moveable contact if the electronic module is mounted in the system in a second orientation different from the first orientation.

15. The system of claim 13, wherein the first order and the second order are opposite orders of the identifiers of the plurality of bays.

16. The system of claim 13, wherein the moveable contact comprises an electrical switch that is open based on the moveable contact being in a first position, and that is closed based on the moveable contact being in a second position different from the first position, the electrical switch being open causing a control signal to the switch assembly to have a first state, and the electrical switch being closed causing the control signal to the switch assembly to have a second state different from the first state.

17. The system of claim 13, wherein the memory comprises a first memory device and a second memory device, the first memory location is in the first memory device, and the second memory location is in the second memory device.

18. The system of claim 17, wherein the first memory device comprises a first write protect input, and the second memory device comprises a second write protect input, and
wherein the first write protect input is activated to block a write to the first memory device responsive to the moveable contact being in a first position, and wherein the second write protect input is activated to block a write to the second memory device responsive to the moveable contact being in a second position different from the first position.

19. A method comprising:
providing a moveable contact and a plurality of bays on an electronic module, the bays to receive respective devices, and the moveable contact engageable with a housing of a system based on a mounting orientation of the electronic module in the system;
storing a first set of identifiers of the plurality of bays in a first memory location in a memory of the electronic module;
storing a second set of identifiers of the plurality of bays in a second memory location in the memory, wherein the identifiers of the plurality of bays in the first memory location are in a first order, and the identifiers of the plurality of bays in the second memory location are in a second order different from the first order; and
providing a switch assembly on the electronic module, the switch assembly to selectively select the first memory location or the second memory location based on a position of the moveable contact that is according to the mounting orientation of the electronic module.

20. The method of claim 19, further comprising:
providing a control signal having a state that is based on a position of the moveable contact, the control signal to control the switch assembly.
